(19) United States
(12) Patent Application Publication
(10) Pub. No.: US 2010/0011559 A1
(43) Pub. Date: Jan. 21, 2010

(54) Retrofit Seals and Method for Placement in an Existing Groove

(76) Inventors: Edward J. O'Malley, Houston, TX (US); Douglas J. Murray, Magnolia, TX (US); Kevin C. Holmes, Houston, TX (US); Steve Rosenblatt, Houston, TX (US)

Correspondence Address: DUANE MORRIS LLP - Houston, 3200 SOUTHWEST FREEWAY, SUITE 3150, HOUSTON, TX, 77027, US

(21) Appl. No.: 12/174,387

(22) Filed: Jul. 16, 2008

(51) Int. Cl. B23P 9/00

(52) U.S. Cl. 29/445

(57) ABSTRACT

A seal is retrofit to an existing seal groove and made whole after being positioned in the groove. It can be an initial coil shape to allow it to slip over a shaft to get to the groove or it can be in a plurality of sections that are joined in place. The sections can be abutting or overlapping and are preferably coated with a brazing material that will ultimately join such ends. The ends can then have a nano-engineered coating that comprises alternating layers of aluminum and nickel that when initiated with applied heat becomes reactive exothermically to join the ends using the brazing material.

### FIELD OF THE INVENTION

The field of the invention is retrofit applications for seals that are located in grooves so as to upgrade the seal performance without having to redesign the underlying part containing the groove.

### BACKGROUND OF THE INVENTION

Seals are used in a variety of downhole tools. Typically they are disposed around shafts or other components in a circular groove. As frequently they are made of a resilient material such as an elastomer. For a variety of reasons, the service life of such seals, commonly referred to as o-rings may need to be improved. Service life can deteriorate for o-rings for a variety of reasons. The service temperature can rise, the cycling frequency of the parts where the o-ring is mounted can increase or the fluid composition can change. Sometimes the quality of the fluid that is sealed can deteriorate such as when solid contaminant levels rise.

In the past the equipment would be taken out of service and disassembled and another o-ring installed in the pre-existing groove. If it were possible the material for the o-ring might be upgraded to try to get a little longer service life when the equipment was again reassembled and put into service. However, there were limits to the material options available while still retaining a resilient quality in the o-ring so that it could be worked down a shaft to the groove where it was intended to be mounted.

Trying to retrofit with a metal seal in an existing groove in the past was not a workable option because the part with the o-ring groove would have to be redesigned to accept a non-resilient seal. In essence the groove would have to be turned into a shoulder that would allow a metallic ring for example to go over the shaft and then a sleeve would have to be advanced over the shaft against the metallic seal to hold it in position. Doing this would require a full redesign of the part, such as a shaft, and for that reason was not a viable solution in the past.

The present invention focuses on how to retrofit a metallic or other material for a resilient o-ring seal in an existing groove without having to re-engineer the underlying part that has the groove. A single or multi-component design is revealed that is joined either to itself or to other components while in the groove. In that manner the existing groove can be used and the seal material can be upgraded. The cross-sectional shape of the replacement seal can be varied and the section can be solid or tubular. In the preferred embodiment the portions to be joined can be coated with a brazing material for example and then a coating of nano-engineered material such as NanoFoil® made by Reactive NanoTechnologies of Hunt Valley, Md.; www.rntfoil.com. With the replacement seal in position, a heat source starts a reaction that is exothermic in the nano-engineered material and the heat generated in conjunction with the brazing material, for example, then results in making the seal within the groove. If the seal is a one piece helical shape then abutting or overlapping ends can be joined. Alternatively, the seal can start as two or more parts which are joined in the groove to make a unitary seal from the desired materials without re-engineering the underlying part.

The following methods could be considered for alternative methods of joining a seal. Non-densified, i.e. ceramic and powder metal parts could be sintered or densified around the seal groove. A seal could be deposited in the seal groove. This could include a spray on operation of polymer or metal and could include deposition techniques such as laser deposition or cladding, electron beam deposition and so forth such that sealing material was deposited from unformed material into the seal area. Finally a mold in place technique could be used which uses more traditional pressure molding operations to form the seal directly in the seal area.

The following patents are relevant to the discovery and development of the nano-engineered foil that is preferred for use in the present invention.

PAT.NO. Title
1 U.S. Pat. No. 7,361,412 Nanostructured soldered or brazed joints made with reactive multilayer foils
2 U.S. Pat. No. 7,297,626 Process for nickel silicide Ohmic contacts to n-SiC
3 U.S. Pat. No. 7,143,568 Hermetically sealing a container with crushable material and reactive multilayer material
4 U.S. Pat. No. 7,121,402 Container hermetically sealed with crushable material and reactive multilayer material
5 U.S. Pat. No. 6,991,856 Methods of making and using freestanding reactive multilayer foils
6 U.S. Pat. No. 6,991,855 Reactive multilayer foil with conductive and nonconductive final products
7 U.S. Pat. No. 6,863,992 Composite reactive multilayer foil
8 U.S. Pat. No. 6,736,942 Freestanding reactive multilayer foils
9 U.S. Pat. No. 6,596,101 High performance nanostructured materials and methods of making the same
10 U.S. Pat. No. 6,534,194 Method of making reactive multilayer foil and resulting product
11 U.S. Pat. No. 5,547,715 Method for fabricating an ignitable heterogeneous stratified metal structure
12 U.S. Pat. No. 5,538,795 Ignitable heterogeneous stratified structure for the propagation of an internal exothermic chemical reaction along an expanding wavefront and method of making same

These and other aspects of the present invention will become more apparent to those skilled in the art from a review of the detailed description of the preferred embodiment and the associated drawings that appear below while recognizing that the full scope of the invention is to be determined by the appended claims.

### SUMMARY OF THE INVENTION

A seal is retrofit to an existing seal groove and made whole after being positioned in the groove. It can be an initial coil shape to allow it to slip over a shaft to get to the groove or it can be in a plurality of sections that are joined in place. The sections can be abutting or overlapping and are preferably coated with a brazing material that will ultimately join such ends. The ends can then have a nano-engineered coating that comprises alternating layers of aluminum and nickel that when initiated with applied heat becomes reactive exothermically to join the ends using the brazing material.

### BRIEF DESCRIPTION OF THE DRAWINGS

FIG. 1 is a two segment version shown with the segments apart before assembly;

FIG. 2 is the view of FIG. 1 with the segments joined in an abutting manner in a groove;

FIG. 3 shows a one piece helically shaped embodiment before mounting in a groove;

FIG. 4 is the embodiment of FIG. 3 shown outside the groove for clarity and with its ends joined as they would be in the grove;

FIG. 5 is a detail with some wall material removed to create flush surfaces after joining ends.

### DETAILED DESCRIPTION OF THE PREFERRED EMBODIMENT

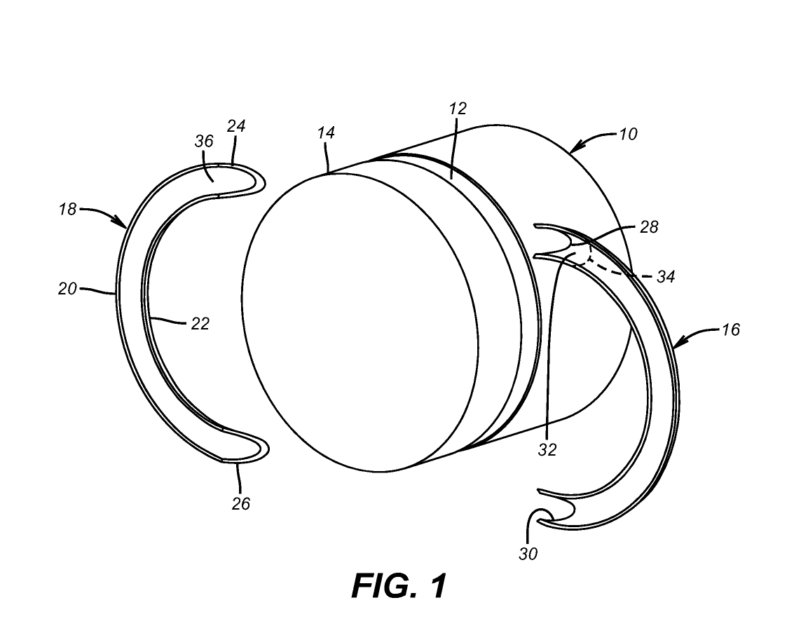

FIG. 1 illustrates an object such as a mandrel 10 that is part of a tool that has a groove 12. Normally the groove 12 houses a resilient o-ring (not shown) and the objective is to replace that o-ring with a seal that will provide better service life without forcing a re-engineering of the part 10. It is preferred to replace the original o-ring with a metallic seal however other joinable and durable materials such as ceramics and composites for example are also contemplated. The problem has been with the use of more rigid materials that it will not be possible to get them over the end 14 to get into groove 12 because they are not resilient. In the past splitting a seal ring has been rejected as a solution because of the difficulties in getting it to seal again once inserted into the groove 12. However, the present invention accepts that challenge and addresses it by providing a joining method for a single or multi-component ring while the ring is in the groove 12.

FIG. 1 shows two segments 16 and 18 that are preferably u-shaped in cross section such that opposed edges 20 and 22 for example will span a gap to be sealed that goes from the curved surface that defines the depth of the groove 12 to a surrounding body (not shown) that encircles the part 10. The u-shape is but one of many optional cross-sectional shapes which can be open such as a u-shape or closed such as a tubular diamond shape. The cross-section can be open throughout or tubular and closed throughout or a combination of part open and part closed. It can also be solid in cross-section or fully tubular while closed or partially or totally open in cross-section as the parts 16 and 18. Metallic is a preferred material but any materials that can function as a seal and be joinable by the described method can be used depending on the parameters of the application. Alternative materials could be ceramics or composites.

Referring back to FIG. 1 the ends 24 and 26 are illustrated schematically. They can be slant cut as shown so as to butt up to slant cut ends 28 and 30 on part 16. The angle of the cut can be varied and it includes the cut at 90 degrees which is a square cut. Apart from butting ends 24 and 28 together for joining in the manner that will be described below, the ends for example 24 and 28 can be overlapped and joined where they contact each other in the overlap areas. For example, end 24 can be placed over end 28 and the overlapping contact areas can be joined in trough 32. Alternatively some portion of the wall in trough 32 to dashed line 34 can be removed and a like amount of wall can be removed from the underside of the trough 36 such that when parts 16 and 18 are brought together troughs 32 and 36 will butt up flush to each other rather than having a step at dashed line 34 if there was no wall removed and the end 24 merely was laid over past end 28. FIG. 5 illustrates one way described above to get a flush mating of troughs 32 and 36. It can be done in other ways such as a groove in the end wall of one part extending over a mating projection in the other part.

The joining method involves putting a soldering or brazing compound on the surfaces to be joined and then adding at least one thick foil layer. The foil consists of hundreds of nano-scale aluminum and nickel layers that are vapor deposited into a thick foil. Alternative material combinations can include TiB2, ZrB2, HfB2, TiC, ZrC, HfC, Ti5Si3, Zr5Si3, Nb5Si3, NiAl, ZrAl, or PdAl. Preferably the soldering or brazing compound or other joining material responsive to heat is placed on the parts to be joined on both sides of the foil. The foil consists of hundreds of nanoscale aluminum and nickel layers that are vapor deposited into a thick foil. Pressure is applied to prevent the components from moving and the chemical reaction between the Al and Ni layers in the foil is activated. Heat from the foil's reaction melts the solder or brazing material layers and enables metallic bonding at room temperature in less than one second. The reaction in the foil may be activated with a small pulse of local energy that can be applied using optical, electrical, or thermal sources. Common examples include an electrical pulse, spark, hot filament, a laser beam, etc.

The average time that it takes for a reaction to start or components to join after activation of the foils is 10 milliseconds, or just 1/100th of a second. The bonding time is essentially instantaneous, and the entire device cools and can be handled within seconds.

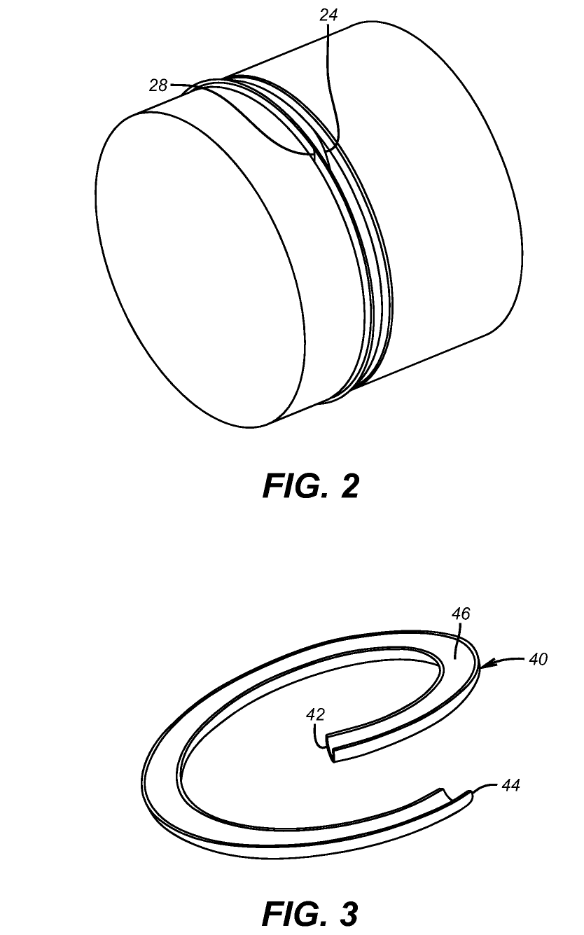

FIG. 2 shows the ends 24 and 28 abutting and joined together in the manner described above in groove 12.

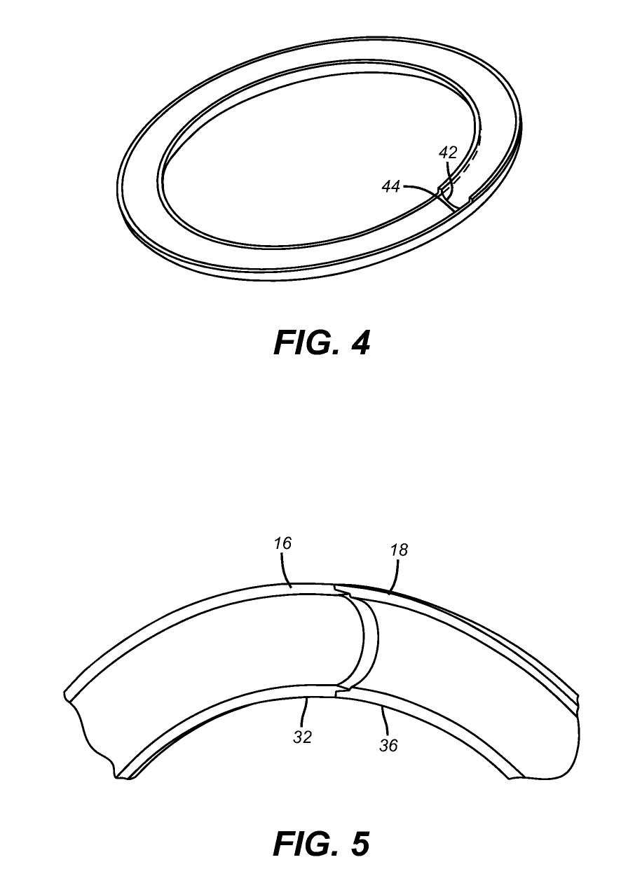

FIGS. 3 and 4 illustrate how a seal can be made in groove 12 using a one piece component 40. It can be fabricated as a helix and have a running length so that when placed in groove 12 the ends 42 and 44 abut or overlap. While the cut is shown as square the ends 42 and 44 can be cut on a slant if they are to be abutted or overlapped. As before with the multi-component design some wall material can be remove at overlapping surfaces so that a continuous trough 46 can be formed even with ends 42 and 44 that overlap. FIG. 4 happens to show the ends abutting. Depending on the resiliency of the selected material, the split ring design of FIG. 3 can encompass 360 degrees and can be made to form a single plane. In that case it is elastically spread to get it into groove 12 for closing with the technique described above. Alternatively the one piece can be a helix that wraps for more than 360 degrees and designed to flex over the object 10 to get into a groove 12. Here again the cross-sectional shape can vary from an open shape such as shown in FIG. 3 being a u-shape or a closed tubular structure in section or a solid section of a desired geometric shape that can present sharp edges for sealing to the groove 12 and the surrounding object as well as blunt ends to accomplish the same purpose. Tubular cross sections can also accommodate a filler material for structural strength or to enhance sealing performance. The material selections can vary as previously described and the filler material should be compatible with well or operating environment conditions.

While the preferred application is for downhole tools allowing for a retrofit of seals without reengineering the part, the split seals whether in one piece or multiple pieces can be used in a variety of application as o-ring replacements. Some downhole applications are subsurface safety valves, seal bores, jars or fishing tools to name a few. The retrofit advantage with the ability to upgrade sealing material and still get a reliable seal without having to reconfigure the part having the seal groove is the advantage of the present invention. The split can be bonded or joined with resistance welding or micro welding techniques, or adhesives and activators such as UV, heat, or chemical bonding agents.

The above description is illustrative of the preferred embodiment and many modifications may be made by those skilled in the art without departing from the invention whose scope is to be determined from the literal and equivalent scope of the claims below.

We claim:

1 A method for installing a seal in an existing seal groove in a body, comprising:
placing a seal element that comprises at least one part with free ends into a groove on a body;
joining said ends in said groove to create a unitary structure capable of sealing between said groove and a surrounding structure to said body.

2. The method of claim 1, comprising:
abutting said ends when joining them.

3. The method of claim 1, comprising:
overlapping said ends when joining them.

4. The method of claim 3, comprising:
removing material from surfaces to be joined before joining them.

5. The method of claim 4, comprising:
making said joined surfaces flush with adjacent seal surfaces.

6. The method of claim 1, comprising:
using a one piece seal element with two free ends.

7. The method of claim 6, comprising:
forming said element as a helix.

8. The method of claim 6, comprising:
forming said element in a single plane.

9. The method of claim 6, comprising:
making the length of said element such that when placed in a groove said ends abut.

10. The method of claim 6, comprising:
making the length of said element such that when placed in a groove said ends overlap.

11. The method of claim 10, comprising:
removing material adjacent said ends so that they are flush with adjacent surfaces of said seal member after they are joined.

12. The method of claim 1, comprising:
using two parts for said seal element.

13. The method of claim 1, comprising:
putting a soldering material or a brazing material on at least one of said ends.

14. The method of claim 13, comprising:
using foil that comprises independent nanoscale layers to heat said soldering or brazing material, said layers comprising TiB2, ZrB2, HfB2, TiC, ZrC, HfC, Ti5Si3, Zr5Si3, Nb5Si3, NiAl, ZrAl, or PdAl;
activating said foil to release heat.

15. The method of claim 14, comprising:
placing soldering or brazing material on said ends and on both sides of said foil.

16. The method of claim 1, comprising:
using foil that consists of nanoscale aluminum and nickel layers to join said ends;
activating said foil to release heat.

17. The method of claim 16, comprising:
using at least one of a metallic, ceramic or composite for said seal element.

18. The method of claim 17, comprising:
forming said part of said seal element to have at least one of an open shape in cross-section and a closed geometric shape in cross-section that is solid or tubular.

19. The method of claim 17, comprising:
making said part from more than one material.

20. The method of claim 18, comprising:
using more than one cross-sectional shape.

21. The method of claim 1, comprising:
creating a bond or joint with resistance welding or micro welding techniques, or adhesives and activators such as UV, heat, or chemical bonding agents.
